(19) United States
(12) Patent Application Publication
(10) Pub. No.: US 2018/0113833 A1
(43) Pub. Date: Apr. 26, 2018

(54) BOARD MANAGEMENT CONTROLLER PERIPHERAL CARD, HOST SYSTEM WITH THE SAME, AND METHOD FOR MANAGING HOST PERIPHERAL MEMBER BY THE SAME

(71) Applicants: Inventec (Pudong) Technology Corporation, Shanghai (CN); INVENTEC CORPORATION, Taipei City (TW)

(72) Inventor: Yung-Ying CHEN, Taipei City (TW)

(21) Appl. No.: 15/470,233

(22) Filed: Mar. 27, 2017

(30) Foreign Application Priority Data
Oct. 21, 2016 (CN) 201610918004.7

(51) Int. Cl. G06F 13/42; G06F 15/78; G06F 3/14; G06F 13/38; G06F 3/02; G06F 21/85

(52) U.S. Cl. CPC G06F 13/4221; G06F 15/7803; G06F 3/14; G06F 2213/0026; G06F 13/387; G06F 3/0227; G06F 21/85; G06F 13/385

(57) ABSTRACT

This present invention provides a board management controller peripheral card, a host system with the same and a method for managing host peripheral member by the same. The host system includes a motherboard, a board management controller peripheral card, and a host peripheral member. The motherboard includes a platform controller hub and a peripheral component interconnect express slot, the peripheral component interconnect express slot is electrically connected to the platform controller hub. The board management controller peripheral card includes a peripheral component interconnect express port and a controller unit. The peripheral component interconnect express port is inserted to the peripheral component interconnect express slot. The controller unit is electrically connected to the peripheral component interconnect express port. The host peripheral member is electrically connected to the controller unit by a wire.

This application claims the benefit of China Patent Application Serial No. 201610918004.7, filed Oct. 21, 2016, the subject matter of which is incorporated herein by reference.

### BACKGROUND OF INVENTION

### 1. Field of the Invention

The present invention is related to a board management controller (BMC) peripheral card for managing host peripheral members, and more particularly is related to a host system with a BMC peripheral card and a method for managing host peripheral members by using the BMC peripheral card.

### 2. Description of the Prior Art

Please refer to FIG. 1, which is a block diagram showing a conventional host system. As shown, the conventional host system PA100 comprises a motherboard PA1, a panel PA2, a fan Pa3, and a power module PA4. The motherboard PA1 includes a platform controller hub PA11 and a peripheral component interconnect express (PCIE) slot PA12, a processor PA13, a computer housing controller PA14, a fan controller PA15, and a power connector PA16. The platform controller hub PA11 is electrically connected to the PCIE slot PA12, the processor PA13, and the computer housing controller PA14, the fan controller PA15 is electrically connected to the fan PA3, and the power connector PA16 is electrically connected to the power module PA4.

As mentioned, for the conventional motherboard without BMC, if the user needs a motherboard with BMC, the user needs to manufacture the motherboard once again to include the BMC, that is, the user needs to redesign the layout of the motherboard such that the cost would be enhanced.

### SUMMARY OF THE INVENTION

In view of the aforementioned conventional motherboard, if it is required to add the BMC in the motherboard without an embedded BMC, the only way is to redesign the motherboard. That is, the original motherboard cannot be effectively used for manufacturing the new motherboard. Therefore, additional labor cost would be wasted for redesigning and remanufacturing the new one. Accordingly, in order to use original motherboard effectively, a host system with a BMC peripheral card is provided in the present invention, which connects the BMC peripheral card externally so as to access the functions of the BMC.

In accordance with the aforementioned object, a host system with a BMC peripheral card is provided. The host system with a BMC peripheral card comprises a motherboard, a BMC peripheral card, and a host peripheral member. The motherboard comprises a platform controller hub and a PCIE slot. The PCIE slot is electrically connected to the platform controller hub. The BMC peripheral card comprises a PCIE port and a controller unit. The PCIE port is utilized for being inserted into the PCIE slot. The controller unit is electrically connected to the PCIE port. The host peripheral member is electrically connected to the controller unit through a conductive wire. The motherboard controls the host peripheral member by using the BMC peripheral card.

In accordance with an embodiment of the present invention, the host system further comprising a storage device. The storage device is electrically connected to the motherboard and has a built-in operating system. The operating system includes an identification information and a BMC driver program. The identification information is corresponding to the host peripheral member, and the BMC driver program is utilized for driving the BMC peripheral card. In accordance with a preferred embodiment of the present invention, the platform controller hub has a built-in firmware, which reads the identification information and transmits the identification information to the BMC peripheral card to have the BMC driver program driving the host peripheral member according to the identification information.

In accordance with an embodiment of the present invention, the controller unit is a power management bus (PMbus) unit, and the host peripheral member is a power module.

In accordance with an embodiment of the present invention, the controller unit is a pulse width modulation (PWM) unit, and the host peripheral member is a fan.

In accordance with an embodiment of the present invention, the controller unit is a general purpose input/output (GPIO) port, and the host peripheral member is a panel.

In accordance with an embodiment of the present invention, the motherboard further comprises a processor, electrically connected to the platform controller hub.

In accordance with the object of the present invention, a BMC peripheral card to be installed in a motherboard with a PCIE slot is provided. The BMC peripheral card comprises a PCIE port and a controller unit. The PCIE port is utilized for being inserted into the PCIE slot. The controller unit is electrically connected to the PCIE port and is electrically connected to a host peripheral member through a conductive wire. The motherboard controls the host peripheral member by using the BMC peripheral card.

In accordance with the object of the present invention, a method for managing a host peripheral member by using a BMC peripheral card is also provided. The method comprises the following steps. Firstly, step (a) is executed to provide a motherboard. The motherboard includes a platform controller hub and a PCIE slot electrically connected with each other, and is operated according to an operating system, wherein the platform controller hub has a built-in firmware, the operating system includes a BMC driver program and a identification information corresponding to a host peripheral member.

Thereafter, step (b) is carried out to use the BMC driver program to drive the BMC peripheral card when the motherboard detects that the BMC peripheral card is inserted into the PCIE slot, wherein the BMC peripheral card has at least one managing rule corresponding to the identification information.

Then, step (c) is carried out to read the identification information by using the firmware of the platform controller hub, and transmit the identification information to the BMC peripheral card.

Finally, after the BMC peripheral card receiving the identification information, step (d) is carried out to use the BMC peripheral card to manage the host peripheral member according to the managing rule corresponding to the identification information.

As mentioned, the present invention is related to a BMC peripheral card for managing host peripheral member, which can resolve the drawback of the existing Internet of Thing (IoT) architecture, which lacks expansion flexibility when an additional BMC is required. Because the BMC peripheral card in accordance with the present invention is electrically connected to the motherboard by using the connection of PCIE standard and is also electrically connected to the host peripheral member directly in order to control the host peripheral member, the original motherboard may obtain the function of BMC without the need of hardware modification such that the cost can be reduced and the application would be more convenient.

### BRIEF DESCRIPTION OF THE DRAWINGS

The present invention will now be specified with reference to its preferred embodiment illustrated in the drawings, in which:

FIG. 1 is a block diagram of a conventional host system;

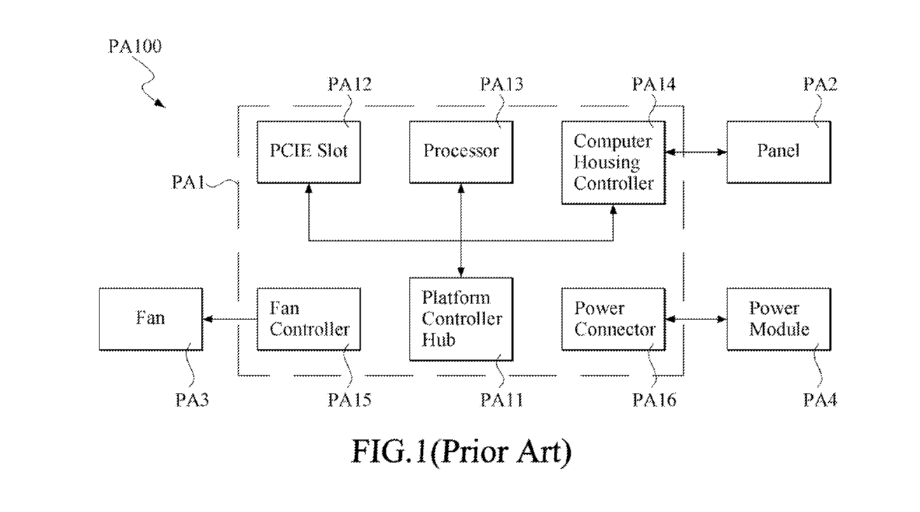

FIG. 2 is a block diagram of a host system with a BMC peripheral card provided in accordance with a preferred embodiment of the present invention; and

FIG. 3 is a flow chart showing a method for managing the host peripheral member by using the BMC peripheral card provided in accordance with a preferred embodiment of the present invention.

### DESCRIPTION OF THE PREFERRED EMBODIMENT

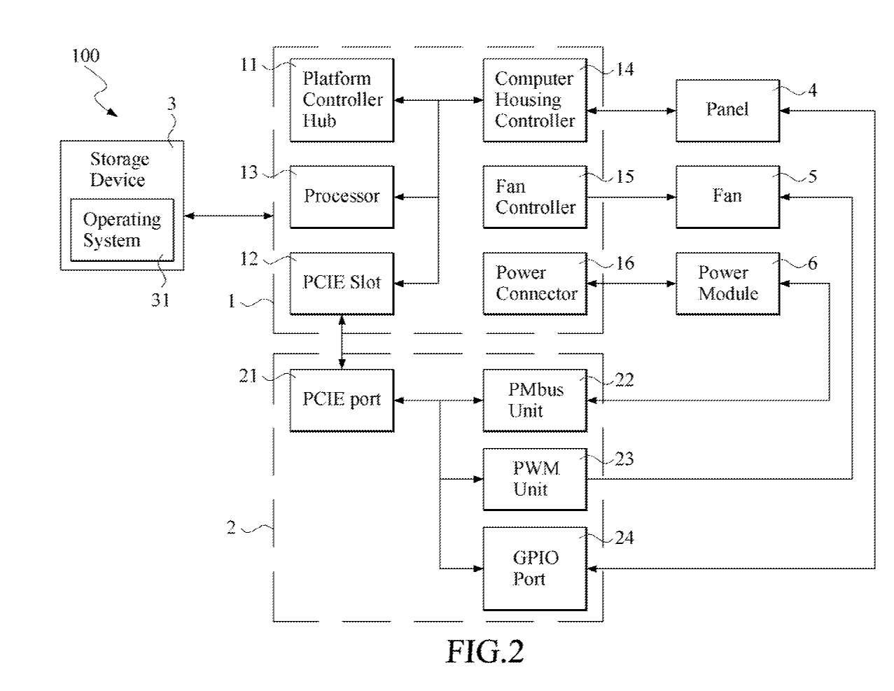

Please refer to FIG. 2, which is a block diagram of a host system with a BMC peripheral card provided in accordance with a preferred embodiment of the present invention. As shown, the host system 100 with a BMC peripheral card comprises a motherboard 1, a BMC peripheral card 2, a storage device 3, and three host peripheral members (i.e. a panel 4, a fan 5, and a power module 6).

The motherboard 1 comprises a platform controller hub 11, a peripheral component interconnect express (PCIE) slot 12, a processor 13, a computer housing controller 14, a fan controller 15, and a power connector 16. The platform controller hub 11 has an built-in firmware. The PCIE slot 12 is electrically connected to the platform controller hub 11. The processor 13 is electrically connected to the platform controller hub 11 and the PCIE slot 12, the computer housing controller 14 is electrically connected to the platform controller hub 11, the PCIE slot 12, and the processor 13.

The BMC peripheral card 2 comprises a PCIE port 21, a power management bus (PMbus) unit 22, a pulse width modification (PWM) unit 23, and a general-purpose input/output (GPIO) port 24. The PCIE port 21 is inserted into the PCIE slot 12 so as to have the PCIE port 21 electrically connected to the PCIE slot 12. The PMbus unit 22, the PWM unit 23, and the GPIO port 24 are electrically connected to the PCIE port 21.

The panel 4 is electrically connected to the GPIO port 24 through a conductive wire. The panel 4 can be an operation panel. The operation panel may include a touch panel, a push button, a turntable or a combination thereof, but the present invention is not so restricted. The fan 5 is electrically connected to the PWM unit 23 through a conductive wire. The power module 6 is electrically connected to the PMbus unit 22 through a conductive wire.

The storage device 3 is electrically connected to the motherboard 1 and has a built-in operating system 31. The operating system 31 includes an identification information and a BMC driver program. The identification information is corresponding to the panel 4, the fan 5, and the power module 6, and the BMC driver program is utilized for driving the BMC peripheral card 2.

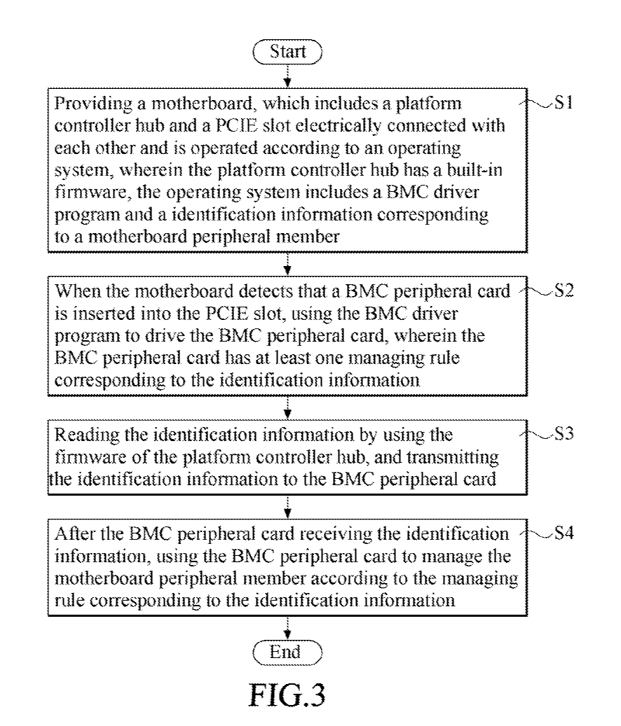

Please also refer to FIG. 3, which is a flow chart showing a method for managing the host peripheral member by using the BMC peripheral card provided in accordance with a preferred embodiment of the present invention. As shown, the method for managing host peripheral members (i.e. the panel 4, the fan 5 and the power module 6) by using a BMC peripheral card 2 is also provided in the present invention. Firstly, step S1 is executed to provide a motherboard 1. The motherboard 1 includes a platform controller hub 11 and a PCIE slot 12 which are electrically connected with each other, and the motherboard 1 is operated according to an operating system 31. The platform controller hub 11 has a built-in firmware, and the operating system 31 includes the BMC driver program and the identification information corresponding to the host peripheral members (i.e. the panel 4, the fan 5, and the power module 6), such as the model numbers of the panel, the fan and the power module.

Thereafter, step S2 is carried out to use the BMC driver program to drive the BMC peripheral card 2 when the motherboard 1 detects that the BMC peripheral card 2 is inserted into the PCIE slot 12, wherein the BMC peripheral card 2 has at least one managing rule corresponding to the identification information. However, in practice, the BMC peripheral card 2 may have a plurality of managing rules corresponding to the identification information. For example, the BMC peripheral card 2 of the present embodiment has at least three managing rules corresponding to the panel model number, the fan model number, and the power module model number. The managing rule corresponding to the fan module number may be used to control rotational speed of the fan 5 in different environmental conditions. In addition, after the BMC peripheral card 2 has been inserted into the PCIE slot 12, the host peripheral members (i.e. the panel 4, the fan 5, and the power module 6) may be further electrically connected to the BMC peripheral card 2 through the conductive wires.

Then, step S3 is carried out to read the identification information by using the firmware of the platform controller hub 11, and transmit the identification information to the BMC peripheral card 2. Because the BMC peripheral card 2 has been driven by the motherboard 1 by using the BMC driver program, the firmware of the platform controller hub 11 may transmit the identification information included in the operating system 31 to the BMC peripheral card 2 such that the BMC peripheral card 2 can be driven to operate according to the identification information.

Finally, step S4 is carried out to use the BMC peripheral card 2 to manage the host peripheral members (i.e. the panel 4, the fan 5, and the power module 6) according to the managing rules corresponding to the identification information. Because the BMC peripheral card 2 has the managing rules corresponding to the identification information, after the BMC peripheral card 2 receiving the identification information to identify that the connected host peripheral members are the panel 4, the fan 5, and the power module 6, the BMC peripheral card 2 may manage these host peripheral members according to the corresponding managing rules. For example, after the BMC peripheral card 2 identifies that the connected host peripheral member is the fan 5, the BMC peripheral card 2 would manage the rotational speed of the fan 5 at different temperatures according to the managing rule of the fan 5. Thereby, after the BMC peripheral card 2 in accordance with the present invention has been inserted in the PCIE slot 12, the aforementioned steps can be executed to drive the BMC peripheral card 2 to manage the host peripheral members.

In conclusion, the motherboard 1 is electrically connected to the BMC peripheral card 2 through the electrical connection between the PCIE slot 12 and the PCIE port 21, the BMC driver program included in the storage device 3 can be used to drive the BMC peripheral card 2, and the built-in firmware of the platform controller hub 11 may read the identification information stored in the storage device 3, such that the BMC peripheral card 2 can be driven to manage the panel 4, the fan 5, and the power module 6 according to the identification information.

For the conventional motherboard without an embedded BMC, if it is required to obtain the function of the BMC, the only way is to redesign the motherboard. In contrast, because the BMC peripheral card provided in accordance with the present invention is externally electrically connected to the motherboard through the connection of PCIE standard, and the BMC peripheral card is used to manage the host peripheral members such as the panel, the fan and the power module directly with the help of the firmware and the BMC driver program. Thereby, the original motherboard may obtain the function of BMC without the need to redesign the motherboard such that the motherboard without the BMC function can be fully utilized and the cost can be reduced.

While the present invention has been particularly shown and described with reference to a preferred embodiment, it will be understood by those skilled in the art that various changes in form and detail may be without departing from the spirit and scope of the present invention.

What is claimed is:

1. A host system with a board management controller (BMC) peripheral card, comprising:
a motherboard, comprising:
a platform controller hub; and
a peripheral component interconnect express (PCIE) slot, electrically connected to the platform controller hub;
a BMC peripheral card, comprising:
a PCIE port, utilized for being inserted into the PCIE slot; and
a controller unit, electrically connected to the PCIE port; and
a host peripheral member, electrically connected to the controller unit through a conductive wire;
wherein the motherboard controls the host peripheral member by using the BMC peripheral card.

2. The host system with a BMC peripheral card of claim 1, further comprising a storage device, electrically connected to the motherboard and having a built-in operating system, wherein the operating system includes an identification information and a BMC driver program, the identification information is corresponding to the host peripheral member, and the BMC driver program is utilized for driving the BMC peripheral card.

3. The host system with a BMC peripheral card of claim 2, wherein the platform controller hub has a built-in firmware, which reads the identification information and transmits the identification information to the BMC peripheral card to have the BMC driver program driving the host peripheral member according to the identification information.

4. The host system with a BMC peripheral card of claim 1, wherein the controller unit is a power management bus (PMbus) unit, and the host peripheral member is a power module.

5. The host system with a BMC peripheral card of claim 1, wherein the controller unit is a pulse width modulation (PWM) unit, and the host peripheral member is a fan.

6. The host system with a BMC peripheral card of claim 1, wherein the controller unit is a general-purpose input/output (GPIO) port, and the host peripheral member is a panel.

7. The host system with a BMC peripheral card of claim 1, wherein the motherboard further comprises a processor, electrically connected to the platform controller hub.

8. A BMC peripheral card, installed in a motherboard with a PCIE slot, and the BMC peripheral card comprising:
a PCIE port, utilized for being inserted into the PCIE slot; and
a controller unit, electrically connected to the PCIE port, and electrically connected to a host peripheral member through a conductive wire;
wherein the motherboard controls the host peripheral member by using the BMC peripheral card.

9. A method for managing a host peripheral member by using a BMC peripheral card, comprising:
(a) providing a motherboard, which includes a platform controller hub and a PCIE slot electrically connected with each other and is operated according to an operating system, wherein the platform controller hub has a built-in firmware, the operating system includes a BMC driver program and an identification information corresponding to a host peripheral member;
(b) when the motherboard detects that a BMC peripheral card is inserted into the PCIE slot, using the BMC driver program to drive the BMC peripheral card, wherein the BMC peripheral card has at least one managing rule corresponding to the identification information;
(c) reading the identification information by using the firmware of the platform controller hub, and transmitting the identification information to the BMC peripheral card; and
(d) after the BMC peripheral card receiving the identification information, using the BMC peripheral card to manage the host peripheral member according to the at least one managing rule corresponding to the identification information.
